(19) United States
(12) Patent Application Publication
(10) Pub. No.: US 2026/0045063 A1
(43) Pub. Date: Feb. 12, 2026

(54) SYSTEM AND METHOD FOR USING SEMANTIC SEGMENTATION FOR INSTANCE DELINEATION

(71) Applicant: GEOX GIS INNOVATIONS LTD., PETACH TIKVA (IL)

(72) Inventors: LIOR SHABTAY, RAMAT GAN (IL); ELI LAVI, PETACH TIKVA (IL)

(21) Appl. No.: 19/292,975

(22) Filed: Aug. 7, 2025

(30) Foreign Application Priority Data
Aug. 8, 2024 (IL) 314858

(51) Int. Cl. G06V 10/26; G06T 3/40; G06V 10/34; G06V 10/774

(52) U.S. Cl. CPC G06V 10/26; G06T 3/40; G06V 10/34; G06V 10/774

(57) ABSTRACT

A computer-implemented method includes receiving an initial contour image comprising contour information of a plurality of objects, the contour information contains one or more gaps thereby constituting a first number of gaps, utilizing a machine learning model trained to close gaps in contours to close at least one gap in the initial contour image and creating a closed contour image comprising contour information of the plurality of objects where a quantity of gaps in the closed contour image is smaller than the first number. A system includes an object delineation system (ODS) with a Closed Contour Generic Model (CCGM) machine learning model trained to close gaps in contours configured to receive an initial contour image that includes contour information with one or more gaps and utilize the CCGM to close at least one gap and create a closed contour image including contour information with less gaps.

### FIELD

The invention relates to semantic segmentation in general and to using semantic segmentation to provide instance delineation.

### BACKGROUND

Semantic segmentation is the task of classifying and grouping together pixels of an image based on defined categories (classes). Each pixel in the image is classified to a category by labelling it with a label indicating a specific class. Each category represents one type of object. Neighbouring pixels of the same class are grouped together into a segment.

State of the art semantic segmentation solutions are based on various deep neural network models. The models include Deep Convolutional Neural Network (DCNN) models for semantic segmentation such as the Fully Convolutional Network (FCN), the Pyramid Scene Parsing Network (PSPNet), Segmentation Network (SegNet) and U-Net. The models also include transformer-based networks, such as a model made of DINO (self-Distillation with NO labels) or DINOv2 backbone, with semantic segmentation head.

FIG. 1A, to which reference is now made, is a schematic illustration of an exemplary image 10 containing a single object 15. A semantic segmentation model may assign a label X to pixels of object 15 indicating their classification to class X while other pixels may be assigned another label indicating they are not classified as class X, typically the other label may be a background class.

When an image contains several disjoint objects of the same class, as illustrated in image 12 of FIG. 1B, to which reference is now made, the objects can be easily identified and delineated using semantic segmentation models and each detected distinct segment is a distinct object being an instance of the class. Image 12 contains two objects 15A and 15B. During the semantic segmentation process, pixels of both objects 15A and 15B may be labelled as class X (while other pixels may be assigned another label, such as background, indicating they are not classified as class X) and the pixels labelled as class X may be easily delineated into two distinct segments, indicative of objects 15A and 15B.

FIG. 1C, to which reference is now made, is a schematic illustration of an image 14 containing two adjacent objects 15C and 15D. During the semantic segmentation process, pixels of both objects 15C and 15D may be labelled as class X. When the instances of a class are adjacent, as objects 15C and 15D are, the semantic segmentation model may identify the adjacent instances as a single segment, and when the semantic segments are used as indication of object instances, the two distinct instances 15C and 15D may be wrongly identified as a single object since there is no clear separation between them.

FIG. 2, to which reference is now made, is an example of an original image 22 of a sky with clouds, for which segmentation to individual clouds is required. Original image 22, with multiple clouds 20, may be fed as an input to a semantic segmentation model aiming at identifying each cloud. Clouds 20A, 20B, 20C, 20D and 20E, located at the bottom of original image 22, are close to each other and partially overlap. Image 24 contains the output of a standard semantic segmentation model. In this case, image 24 contains a single segment 20X. It may be noted that the desired segmentation result should have contain a distinct segment for each of the clouds 20A, 20B, 20C, 20D and 20E.

The result of standard semantic segmentation, where each object type is represented by a specific class, may not always allow for the separation of or distinction between overlapping or touching objects, resulting in a single big segment. To address this issue and identify individual objects in challenging scenarios (e.g., when objects are close to each other or overlap), existing solutions enhance the training dataset with additional information. This added information helps separate overlapping or touching objects.

One solution uses a classic semantic segmentation model that maps each pixel to a class, while some pixels in the training set are mapped to one or more new classes to assist in distinguishing between touching or overlapping objects. Any off-the-shelf semantic segmentation model can be trained and used with this approach, however these models tend to provide imperfect results for the additional defined classes. Consequently, a postprocessing procedure is needed to individually segment the objects. This postprocessing procedure must be applied to every segmented image. The postprocessing procedures involve applying various graphic algorithms to the segmentation results, which generally need to be tailored for each specific problem and dataset and often do not resolve all the issues.

Another solution involves using modified or entirely different models that need to be developed and trained for each specific segmentation task.

Yet another solution involves using both modified or new models followed by postprocessing. One of the graphic algorithms used during postprocessing is the watershed algorithm that can separate different objects in an image. The watershed algorithm needs information related to the original image, such as per-pixel estimated distance from the border, in addition to the output of the semantic segmentation to operate. This means that a standard off-the-shelf semantic segmentation model is insufficient, necessitating an amended or different model.

It may be also noted that the current solutions for improving the segmentation results are specific to a domain and dataset characteristics and are therefore not generic and need careful calibration for every domain.

### SUMMARY

There is provided, in accordance with an embodiment of the invention, a system that includes at least one memory, at least one processor communicatively coupled to the memory and an object delineation system (ODS) operated by the at least one processor, the ODS includes a Closed Contour Generic Model (CCGM) which is a machine learning model trained to close gaps in contours. The ODS being configured to receive an initial contour image that includes contour information of a plurality of objects, the contour information contains one or more gaps constituting a first number of gaps, utilize the CCGM to close at least one gap in the initial contour image, and create a closed contour image including contour information of the plurality of objects where the quantity of gaps in the closed contour image is smaller than the first number.

Additionally, in accordance with an embodiment of the invention, the ODS includes a preprocessing module configured to prepare the initial contour image to be utilized by the CCGM.

Moreover, in accordance with an embodiment of the invention, the preprocessing module is configured to reduce the resolution of the initial contour image, skeletonize borders in the initial contour image, increase a contrast between the borders and background and dilate the borders.

Furthermore, in accordance with an embodiment of the invention, the CCGM is a semantic segmentation model.

Still further, in accordance with an embodiment of the invention, a training set used to train the CCGM includes a variety of images with incomplete contours.

Moreover, in accordance with an embodiment of the invention, the ODS further includes a postprocessing module configured to create a final segmented image where each object is distinctly identified.

Additionally, the postprocessing module further comprises a delate polygon flow configured to fill closed contours in closed contour image with pixels representing a specific object, polygonise and remove the contour around objects in closed contour image, and dilate objects in closed contour image.

Furthermore, in accordance with an embodiment of the invention, the postprocessing module further comprises a skeletonize borders flow configured to skeletonize the contours in closed contour image and fill closed contours in closed contour image with pixels representing a specific object.

Still further, in accordance with an embodiment of the invention, the postprocessing module is further configured to receive an output generated by a standard semantic segmentation model that has processed an original image and decide which closed contour in closed contour image is a contour of an object and create an object segment exclusively for contours of objects.

Moreover, in accordance with an embodiment of the invention, the postprocessing module is further configured to receive initial contour image; and combine contour information of original parts from initial contour image and contour information added by the CCGM for closing the gaps from closed contour image.

There is provided, in accordance with an embodiment of the invention, a computer-implemented method that includes receiving an initial contour image comprising contour information of a plurality of objects, the contour information contains one or more gaps thereby constituting a first number of gaps, utilizing a machine learning model trained to close gaps in contours to close at least one gap in the initial contour image; and creating a closed contour image comprising contour information of the plurality of objects wherein a quantity of gaps in the closed contour image is smaller than the first number.

Moreover, in accordance with an embodiment of the invention, the computer-implemented method also includes preparing the initial contour image to be utilized by the CCGM.

Additionally, in accordance with an embodiment of the invention, the computer-implemented method further includes reducing a resolution of the initial contour image, skeletonizing borders in the initial contour image, increasing a contrast between the borders and background, and dilating the borders.

Furthermore, in accordance with an embodiment of the invention, the CCGM is a semantic segmentation model.

Still further, in accordance with an embodiment of the invention, the training set used to train the CCGM includes a variety of images with incomplete contours.

Moreover, in accordance with an embodiment of the invention, the computer-implemented method further includes receiving a closed contour image, and creating a final segmented image where each object is distinctly identified.

Additionally, in accordance with an embodiment of the invention, the computer-implemented method further includes filling closed contours in closed contour image with pixels representing a specific object, polygonising and removing the contour around objects in closed contour image, and dilating objects in closed contour image.

Moreover, in accordance with an embodiment of the invention, the computer-implemented method further includes skeletonizing the contours in closed contour image and filling closed contours in closed contour image with pixels representing a specific object.

Furthermore, in accordance with an embodiment of the invention, the computer-implemented method further includes receiving an output generated by a standard semantic segmentation model that has processed an original image, and deciding which closed contour in closed contour image is a contour of an object and creating an object segment exclusively for contours of objects.

Still further, in accordance with an embodiment of the invention, the computer-implemented method further includes receiving an initial contour image; and combining contour information of original parts from initial contour image and contour information added by the semantic segmentation machine learning model for closing the gaps from closed contour image.

### BRIEF DESCRIPTION OF THE DRAWINGS

The invention will be understood and appreciated more fully from the following detailed description taken in conjunction with the appended drawings in which:

FIG. 1A is a schematic illustration of an exemplary image containing a single object;

FIG. 1B is a schematic illustration of an exemplary image containing two disjoint objects of the same class;

FIG. 1C is a schematic illustration of an exemplary image containing two adjacent objects;

FIG. 2 is an example of an image and the results provided by state-of-the-art semantic segmentation tools;

FIG. 3A is a schematic illustration of an image containing the borders of two distant objects;

FIG. 3B is a schematic illustration of an image containing the borders of two adjacent objects;

FIG. 4A is a schematic illustration showing an input image provided to an object delineation system (ODS) constructed and operative in accordance with an embodiment of the invention;

FIG. 4B is a schematic illustration of the possible representations of objects in a final segmented image accordance with an embodiment of the invention;

FIG. 4C is an example of an input and an output of an ODS constructed and operative in accordance with an embodiment of the invention;

FIG. 5 is a schematic illustration of an ODS, constructed and operative in accordance with an embodiment of the invention;

FIG. 6 is a schematic illustration of an optional flow implemented by a preprocessing module of the ODS in accordance with an embodiment of the invention;

FIG. 7 is a schematic illustration of the training phase of a Closed Contour Generic Model (CCGM) of the ODS, constructed and operative in accordance with an embodiment of the invention;

FIG. 8 is a schematic illustration of an optional dilate polygons flow implemented by the postprocessing module of the ODS in accordance with an embodiment of the invention;

FIG. 9 is a schematic illustration of optional skeletonize borders flow implemented by the postprocessing module of the ODS in accordance with an embodiment of the invention;

FIG. 10 is a schematic illustration of an optional flow implemented by the postprocessing module of the ODS in accordance with an embodiment of the invention using additional input information;

FIG. 11 is schematic illustration of an additional optional flow implemented by a postprocessing module of the ODS in accordance with an embodiment of the invention using additional input information;

FIG. 12 is a schematic illustration of a pipeline performing instance segmentation inference using ODS in accordance with an embodiment of the invention to improve object delineation;

FIG. 13 is an example of images created in the various steps of the pipeline of FIG. 12 in accordance with an embodiment of the invention; and

FIG. 14 is a schematic illustration of an alternative embodiment of postprocessing module of ODS uses to distinguish between areas inside closed contours being the objects of interest and other closed areas that are not objects.

It will be appreciated that for simplicity and clarity of illustration, elements shown in the figures have not necessarily been drawn to scale. For example, the dimensions of some of the elements may be exaggerated relative to other elements, for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the invention may be practiced without these specific details.

In other instances, well-known methods, procedures, features and components have not been described in detail so as not to obscure the invention. In the accompanied drawings, similar numbers refer to similar elements in different drawings.

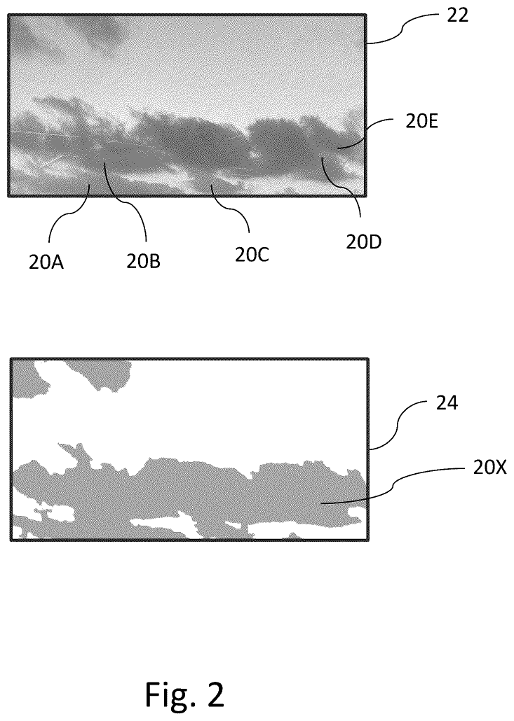

Applicant has realized that semantic segmentation sometimes fails to create distinct segments for the objects in an image when the classes used by a model are defined as the objects' categories, and the model was trained to identify each pixel in the image as being part of the class and is labeled accordingly. In many cases, when objects overlap, it becomes challenging to identify individual objects. In such cases, the semantic segmentation model may not recognize each distinct object, resulting in adjacent objects not being individually delineated and instead being identified as a single object as illustrated in FIG. 2.

Methods and systems according to embodiments of the invention use an approach that delineates objects based on their borders. In this approach the original image is first segmented using standard semantic segmentation models to “borders” and “not borders”. However, this segmentation may fail to create a perfect contour around each object, leaving gaps that in turn can compromise the ability to distinguish between neighboring objects.

Embodiments of the invention include a novel model, that operates on these potentially imperfect borders, and is trained to close open gaps in the borders and create closed contours, each closed contour surrounding a distinct object in the original image. This novel model processes the potentially imperfect output of semantic segmentation models trained to segment ‘borders’. In this approach a general class, named ‘border’ class, for denoting the border of objects, is defined as the output of the semantic segmentation model trained to segment ‘borders’, which is also the input of the novel model (instead of, or in addition to, a specific class identifying the object). Pixels that are identified by the semantic segmentation model as being part of the border of an object, are labelled with this ‘border’ class. Pixels that are not part of a border, that represent all the regions in the image that is not a border, may be labelled by a “background” class. It may be noted that any other labeling approach may be used to distinguish between pixels belonging to the border of an object and other pixels. During inference, the novel semantic segmentation model, processes the potentially imperfect output of the semantic segmentation model, and operates to close any gaps in the contours, formed by the ‘border’ class pixels.

Methods and systems according to embodiments of the invention are directed at improving delineation of objects using semantic segmentation by introducing an Object Delineation System (ODS), capable of receiving an image containing contours of objects, some of them not properly closed, closing the gaps to produce an image having closed contours and identify each distinct object in the image.

The ODS is a generic system that can be used for closing gaps of contours of any type of object. It is agnostic to the segmentation model used for creating the ‘border’ class data, to the type of objects which are to be delineated and to the characteristics of the provided dataset.

The ODS provides a generic model that may be capable of receiving an image containing open and closed contours (borders of objects) and creating an image in which the contours are closed (fixed) thereby may fix incomplete contours created by various semantic segmentation models. The image with closed contours may then be used to identify individual objects even when they overlap.

Methods and systems according to embodiments of the invention may use the ODS to enable identifying distinct instances of a class in a challenging image. The pipeline may first apply a semantic segmentation model on original images 22 and segment those pixels belonging to the border class, potentially creating an image with potentially incomplete contours. The pipeline may then feed the image with the incomplete contours to the ODS that may fix any incomplete contour and create an image having a closed contour identifying an object. The distinct objects in the image with the closed contours may then be identified and delineated.

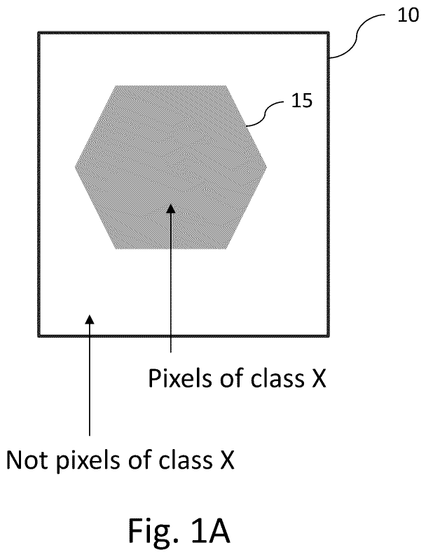

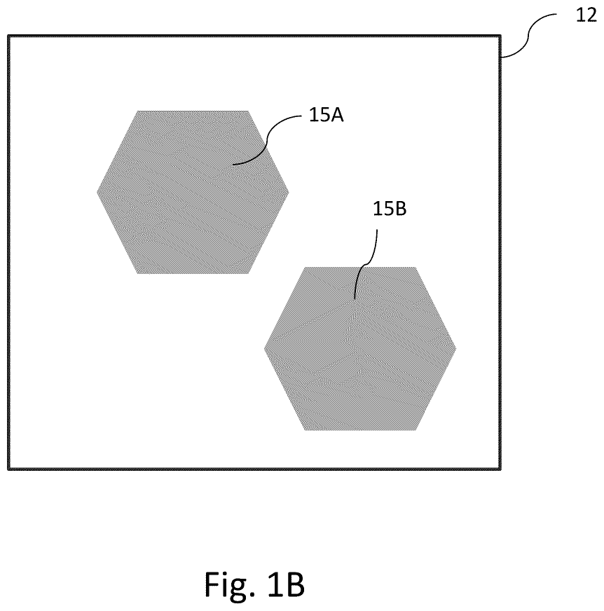

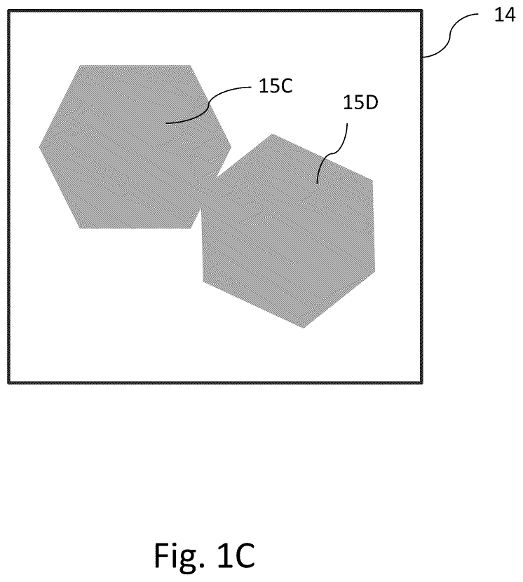

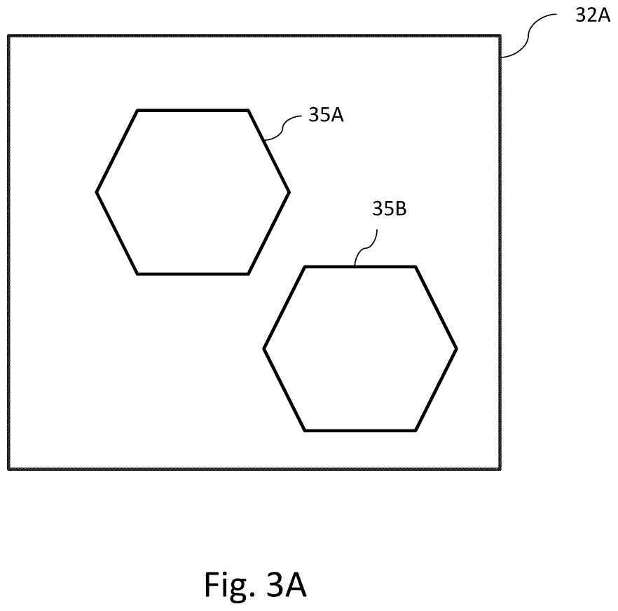

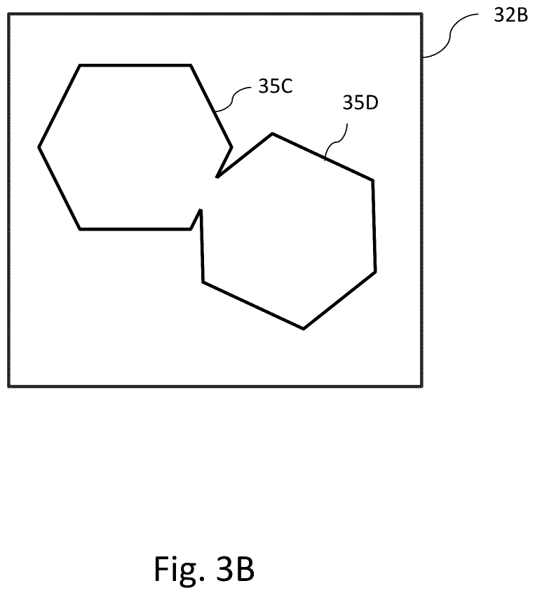

FIG. 3A, to which reference is now made, is a schematic illustration of an initial contour image 32A containing the borders of two distant objects 35A and 35B. During the semantic segmentation process, pixels of the border of both objects 35A and 35B may be labelled with the ‘border’ class and may be the contours of objects 15A and 15B of FIG. 1B. It may be noted that the patterns of borders forming the contour of the objects in each initial contour image may have different characteristics such as thickness, color, shape of line, sketched style, compound type, cap type, joint type, shape of the end of the line, uniformity of the line, and the like.

FIG. 3B, to which reference is now made, is a schematic illustration of an initial contour image 32B containing the borders of two adjacent objects 35C and 35D. During the semantic segmentation process, pixels of the border of both objects 35C and 35D may be labelled with the ‘border’ class label and may be the contours of objects 35C and 35D. It may be noted that both contours 35C and 35D have a gap in the overlapping area.

Using this approach alone may not provide the necessary functionality of properly delineating objects in challenging images since the process of identification and delineation of objects according to their contour in this case may identify the borders of the adjacent instances 35C and 35D as a single contour surrounding a single object and does not properly delineate between the objects. The contours of objects 35C and 35D, created in this case by the predicted ‘border’ class may contain gaps, which may compromise the ability to distinguish between adjacent objects. When the gap in each contour appears between adjacent objects it can make the two contours appear as a single one.

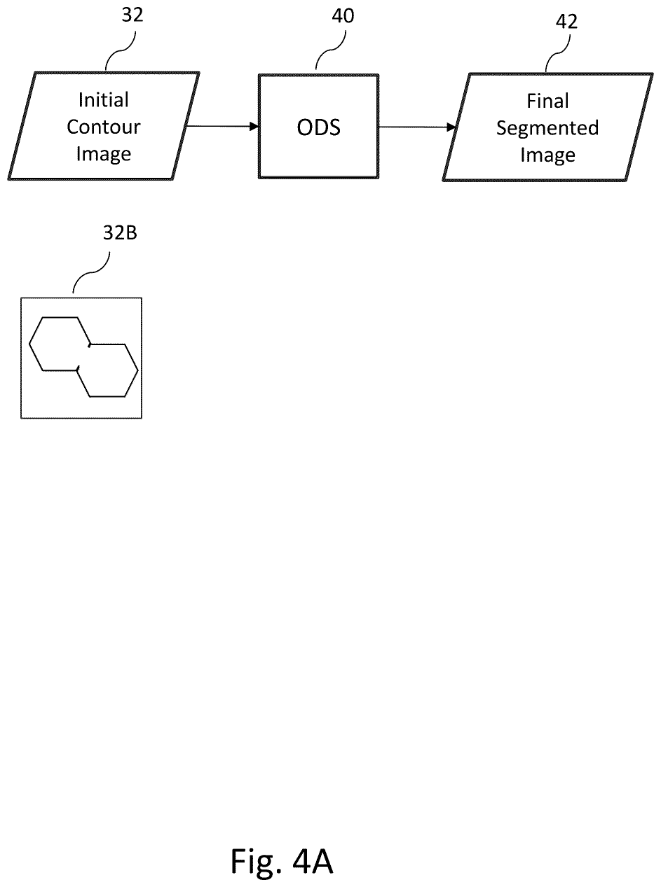

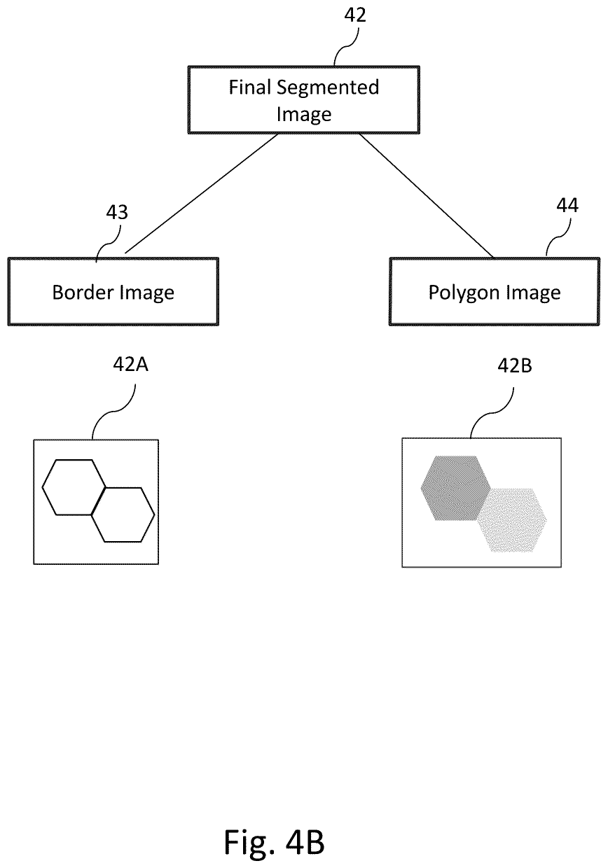

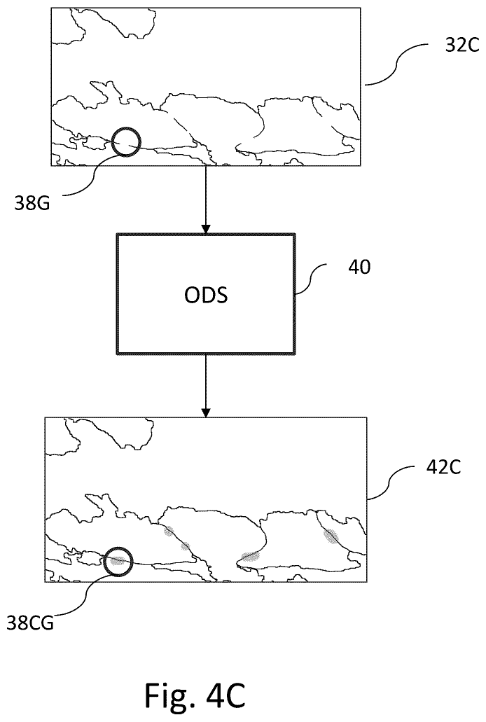

FIG. 4A, to which reference is now made, is a schematic illustration showing an input image provided to an object delineation system (ODS) 40, constructed and operative in accordance with an embodiment of the invention, and the output image provided by ODS 40 after processing the input image. The input to ODS 40 may be an initial contour image 32 (e.g., 32B containing two contours surrounding two objects, each with a gap, the gap in the overlapping part of the two objects). The output of ODS 40 is final segmented image 42 where each object is distinctly identified.

FIG. 4B, to which reference is now made, is a schematic illustration of the possible representations of objects in final segmented image 42. Final segmented image 42 may be a border image 43 in which each object is represented by a surrounding contour (e.g., 42A) or alternatively a polygon image 44 in which each object is represented by a distinct polygon (e.g., 42B).

FIG. 4C, to which reference is now made, is an example of an input and an output of ODS 40. ODS 40 may receive as input an initial contour image 32C with gaps in the contours, for example gap 38G, and may provide a final segmented image 42C with gaps closed by ODS 40 highlighted with gray shadows, for example gap 38CG.

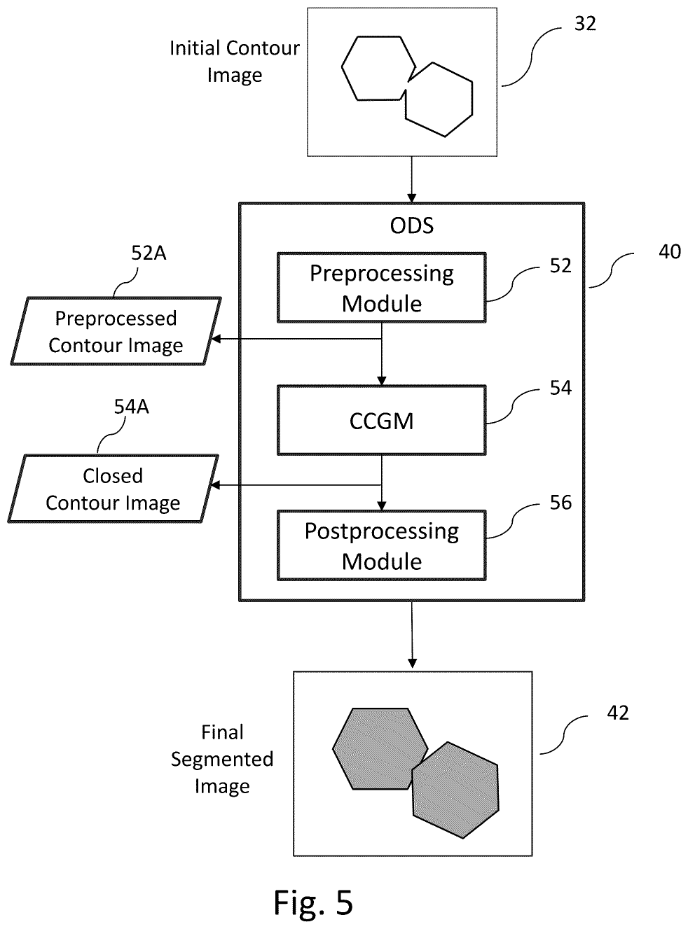

FIG. 5, to which reference is now made, is a schematic illustration of ODS 40, constructed and operative in accordance with an embodiment of the invention. ODS 40 comprises an optional preprocessing module 52 that may receive initial contour image 32 and create a preprocessed contour image 52A, a Closed Contour Generic Model (CCGM) 54 constructed and operative in accordance with an embodiment of the invention, that may receive preprocessed contour image 52A with potential gaps in part of the contours and create a closed contour image 54A. ODS 40 may comprise an optional postprocessing module 56 that may operate on closed contour image 54A and may create a final segmented image 42 with distinct objects delineated from each other.

Preprocessing module 52 may process an initial contour image 32 that includes contours and background (the contours constituting borders of objects) and prepare it to be processed by CCGM 54 e.g. by standardizing the characteristics of the borders. It may be noted that image 32 may contain additional information related to the objects in the image (such as distinct labels to different classes) that may be ignored. CCGM 54 is a machine learning model for semantic segmentation capable of identifying pixels of type ‘border’ class and may be trained to close gaps in contours in an image. Postprocessing module 56 may process closed contour image 54A and may create a final segmented image 42. Final segmented image 42 may include delineated objects and provide a distinct segment for each identified object.

Preprocessing module 52 may be useful to handle contour images created by different semantic segmentation models and different dataset styles in a generic and common manner, so that CCGM 54 may operate seamlessly on a variety of images, with different design, form and quality. Preprocessing module 52 may normalize the look of different patterns of the ‘border’ class forming the contour of the objects with regards to appearance (contour-line width, width variation, line-endings shape and the like). The motivation for normalization is to train CCGM 54 to handle images even if they have originated from a variety of sources and therefore have different looks and style before being pre-processed.

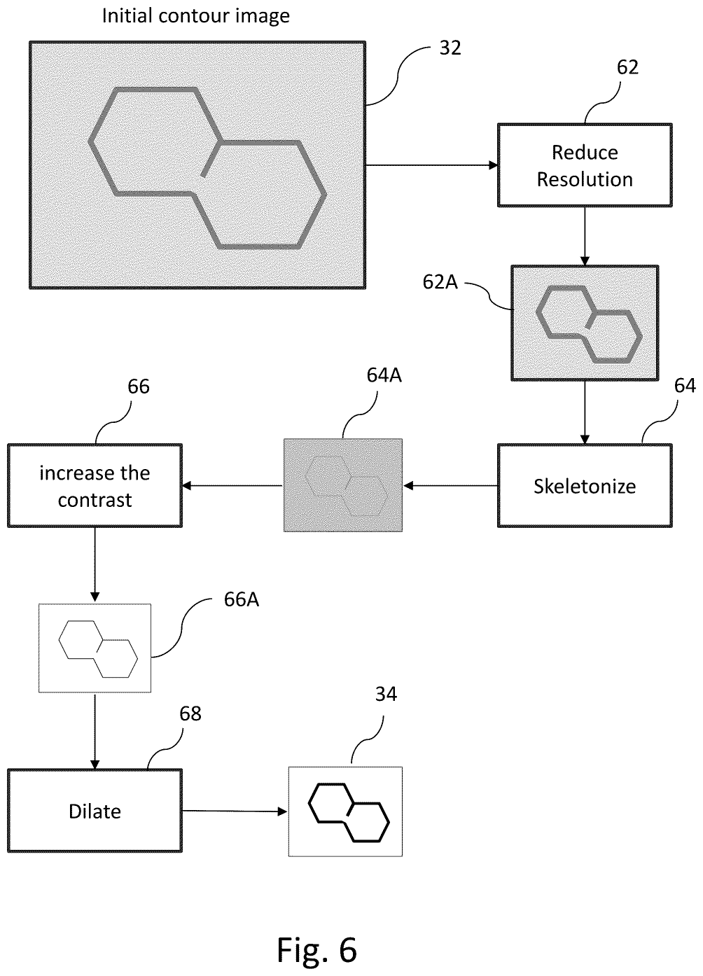

FIG. 6, to which reference is now made, is a schematic illustration of some optional steps that preprocessing module 52 may perform on initial contour image 32 according to an embodiment of the invention. It may be noted that preprocessing module 52 may have more or less steps and may perform any configured steps in any order.

In step 62 preprocessing module 52 may reduce the resolution of initial contour image 32. The resolution reduction may increase the size of the context (part of image) that CCGM 54 may consider for each pixel prediction and may improve the probability of fixing large gaps in large contours. Step 62 may create a reduced resolution contour image 62A.

In step 64, preprocessing module 52 may skeletonize the contours to a single (skeletonized) style and produce a skeletonized contour image 64A. This step may standardize the style of the contours in images provided to CCGM 54 and thus create a generic model capable of handling input images with various contour styles.

In step 66 preprocessing module 52 may increase the contrast between the contours and the background and create a sharp contour image 66A. It may be noted that step 66 may set the color of the contours and the background to any color e.g., the background to white and the contours to black as illustrated in image 66A, the background to black and the contours to white or any other color setting, capable of increasing the contrast between pixels that are part of the contour and pixels that are not.

In step 68, preprocessing module 52 may dilate the contours and create a preprocessed contour image 52A that may comply with a preconfigured style and design. It may be noted that the training process of CCGM 54 (described herein below) may be easier when the contours are dilated.

The functionality of preprocessing module 52 may normalize the contour image to a standard contour format that be handled by CCGM 54.

CCGM 54 may be any semantic segmentation model using any type of machine learning technology trained to close open contours. The machine learning model may be any program that can be trained to perform semantic segmentation including a neural network such as a convolution neural network, a deep convolution neural network, a transformer based deep neural network, and the like. During training, the machine learning model may be optimized to find certain patterns representing object's borders or contours from the dataset and the output of this process is a set of specific rules and/or parameters and/or data structures that is referred as the machine learning model.

CCGM 54 may employ a high weight for the ‘border’ class to increase the chances of learning the borders, for which a minority of the pixels in the images of the dataset belong to and may be trained to identify contours and close them.

During training, the model's parameters (weights and biases) may be updated after each round based on the input images presented in the training dataset and the optimization algorithm used. After each round of training, the model may pass a verification phase for assessing the quality of the model against the ground truth. The assessing procedure may use a variety of metrics.

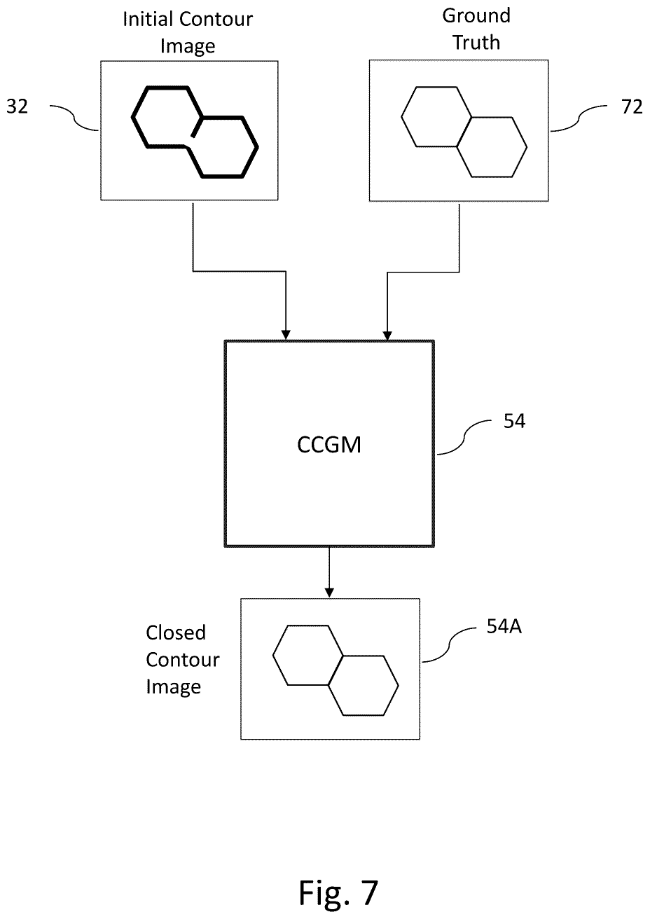

FIG. 7, to which reference is now made, is a schematic illustration of the training phase of CCGM 54, according to an embodiment of the invention. The training set for CCGM 54 may include a set of initial contour images 32 each containing contours (constituting borders of objects) with or without gaps (missing parts). The training set must include a variety of images with incomplete contours (contours with a sufficient number and variety of gaps) to enable the model to learn to close gaps. The respective ground truth images 72 for CCGM 54 may include images with the respective contours closed and without gaps (missing parts) and the predicted closed contour images 54A may be the predicted outcome of CCGM 54.

The training set for training CCGM 54 may be prepared for the training phase in several possible ways. One way is to create the set manually, by intentionally drawing images containing contours of objects and thereby creating ground truth images 72. From this set of manually created ground truth images 72, the respective initial contour image 32 may be created intentionally by erasing parts of the contours, creating different types of gaps. The training set can alternatively be created from images created by a semantic segmentation model with relatively good delineation from which a part of the border of objects may be intentionally erased, for the purpose of creating gaps in the contours artificially. Another way to create the training set is to take those problematic images out of the entire set of images created by a semantic segmentation model. i.e., selecting only those images containing incomplete contours with gaps.

Another way to create a training set for CCGM 54 is to intentionally create a semantic segmentation model that creates contours with gaps. This can be achieved for example by performing a reduced training phase or by trimming it incorrectly during training or inference.

It may be noted that each image in the training set may be created using any method including the methods described herein above and may contain any image of contours with or without gaps created in some way.

When the segmentation task is required to delineate specific objects with a known general contour (e.g., cats having ears and tails) the model may be trained to close gaps of specific classes in a specific way (e.g., when there is a gap in the location of an car, the model may be trained to close the gap in a shape of an ear) an not using a straight line to close the gap.

In this case, CCGM 54 may be trained to fill gaps in contours of specific classes of objects in a specific way using a dataset that includes images of contours of objects of the specific class.

When the segmentation task needs to delineate objects of various classes, CCGM 54 may be trained to fill gaps in contours of various objects, by creating the dataset form images of contours of objects of various classes.

It may be noted that the model can be trained on a dataset having objects having a specific set of characteristics (such as scale, angle of view, rotation, flip and the like) that will generate a model specialized in correcting images with that specific set of characteristics. The model may also be trained on a dataset having objects in a variety of values for each characteristic, making it more generic and capable of correcting contours having different characteristics.

The quality of CCGM 54 may be assessed by the intersection over union (IoU) metric that may evaluate the accuracy of predicted closed contour images 54A against ground truth images 72. The IoU metric provides an estimate of the similarity between the predicted closed contour image 54A created by CCGM 54 and the respective ground truth 72. The IoU metric may be used for testing the performance of CCGM 54 model on a test set containing incomplete object contours that should be fixed. The IoU evaluation metric may be used for checking the performance of CCGM 54 on a verification set and selecting the model having the best (highest) IoU value out of a series of models created during the training phase.

Optionally, as part of the quality evaluation, the ‘border’ class in initial contour images 32 and/or ground truth images 72 may be temporarily dilated by some amount, to provide tolerance to small misalignments between the contours of ground truth images 72 and the fixed contour of predicted closed contour images 54A.

Postprocessing module 56 may handle closed contour images 54A and manipulate them to possibly reverse changes made to the contours by preprocessing module 52 and/or by CCGM 54 and return the contour characteristics such as thickness and color, to their original structure. Additionally, or alternatively, postprocessing module 56 may create final segmented image 42 (that may be a border image 43 or a polygon image 44).

Postprocessing module 56 may change the characteristics (such as the thickness, the color, the shape of the line, the sketched style, the compound type, the cap type, the joint type, the shape of the end of the line, the uniformity of the line, and the like) of the contours of objects in closed contour images 54A and adjust them in closed contour images 54A to those of initial contour image 32 according to any other required or dictated characteristics.

When preprocessing module 52 delates the contours (optional dilate step 68 in FIG. 6), the contours in closed contour image 54A may be thicker than those of initial contour image 32. A similar effect may occur when the weight of the ‘border’ class is increased during training, in order to improve the learning of CCGM 54. When contours in closed contour image 54A are thicker than the ones in contour image 32, the final detected segments may be thinner than the objects in original image 22, (if created by setting the pixels bounded by each closed contour to the object class in the activated flow).

Postprocessing module 56 may dilate the created objects, thin the contours before creating the final instance segments in final segmented image 42, combine information from the initial contour image 32 and other steps that may restore the style of the contours in final segmented image 42 to the style of initial contour image 32.

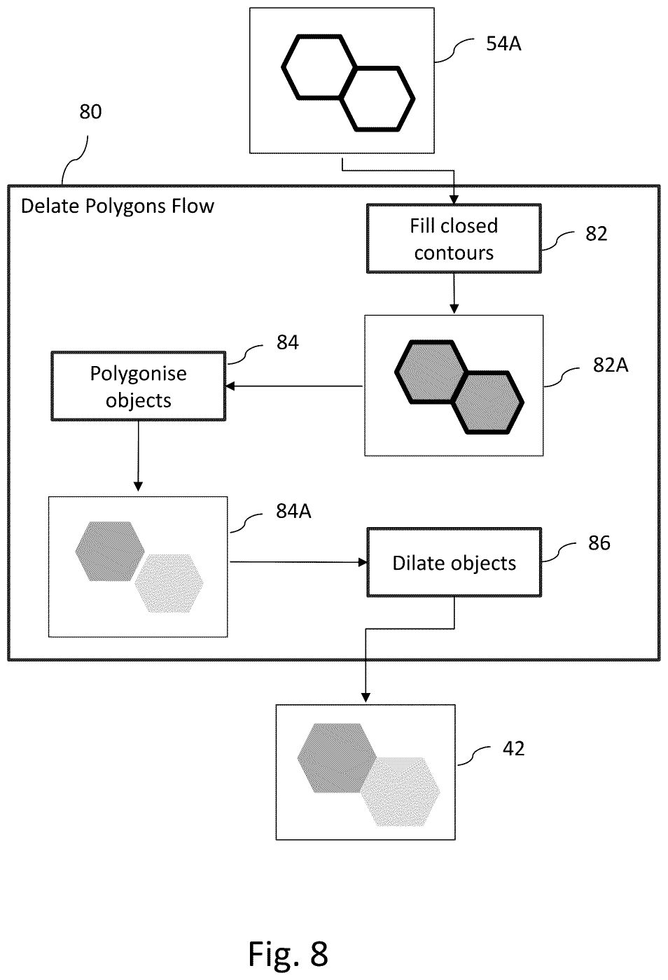

FIG. 8, to which reference is now made, is a schematic illustration of an optional flow of postprocessing module 52 referred herein as dilate polygons flow 80. Delate polygons flow 80 may receive closed contour image 54A and provide as output a final segmented image 42. In step 82, postprocessing module 52 may fill each closed contour with pixels representing a specific object and create a preliminary segmented object image 82A. In step 84, postprocessing module 52 may create a distinct polygon for each object and remove the contour around each object and create a polygonised image 84A. In step 86 postprocessing module 52 may dilate the created objects and create final segmented image 42. The type of final segmented image 42 in the delate polygons flow 80 is a polygon image 44 where each object is described by a dedicated polygon.

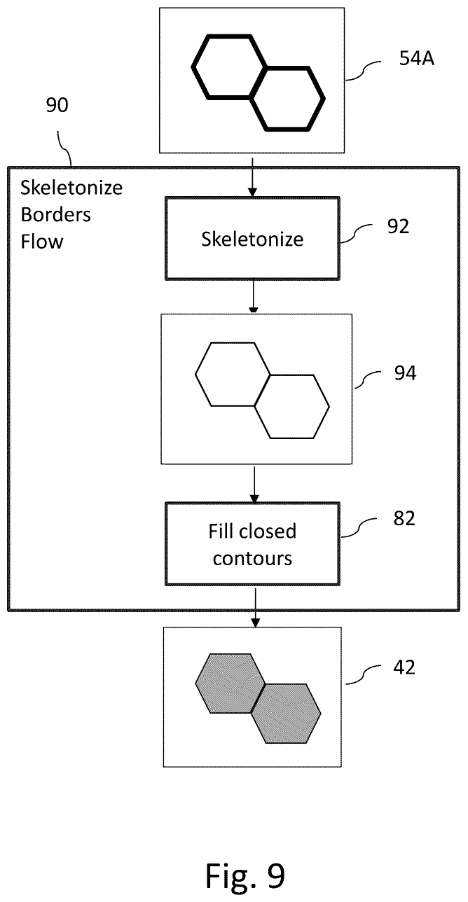

FIG. 9, to which reference is now made, is a schematic illustration of another optional flow of postprocessing module 52, referred herein as skeletonize borders flow 90. Postprocessing module 52 may receive closed contour image 54A and make the object shapes finer by making the contours thinner, using geometric erosion or skeletonizing. In step 92 postprocessing module 52 may skeletonize the contours (make them thinner) and create a skeletonized image 94 and in step 82 postprocessing module 52 may fill each closed contour with pixels representing a specific object and create final segmented image 42. The type of final segmented image 42 in the skeletonized borders flow 90 is border image 43 where each object is surrounded by a closed contour.

It may be noted that final segmented image 42 may be border image 43 or polygon image 44 and postprocessing module 52 may change form one format to another.

The contour of initial contour image 32 might be a bit more precise than the contour of closed contour image 54A (except for the gaps). Postprocessing module 52 may combine initial contour image 32 and closed contour image 54A and utilize the more precise parts. Postprocessing module 52 may use the overlapping parts of the contour from initial contour image 32 and take the parts of the contour, created by CCGM 54 to close the gaps and form closed contour image 54A.

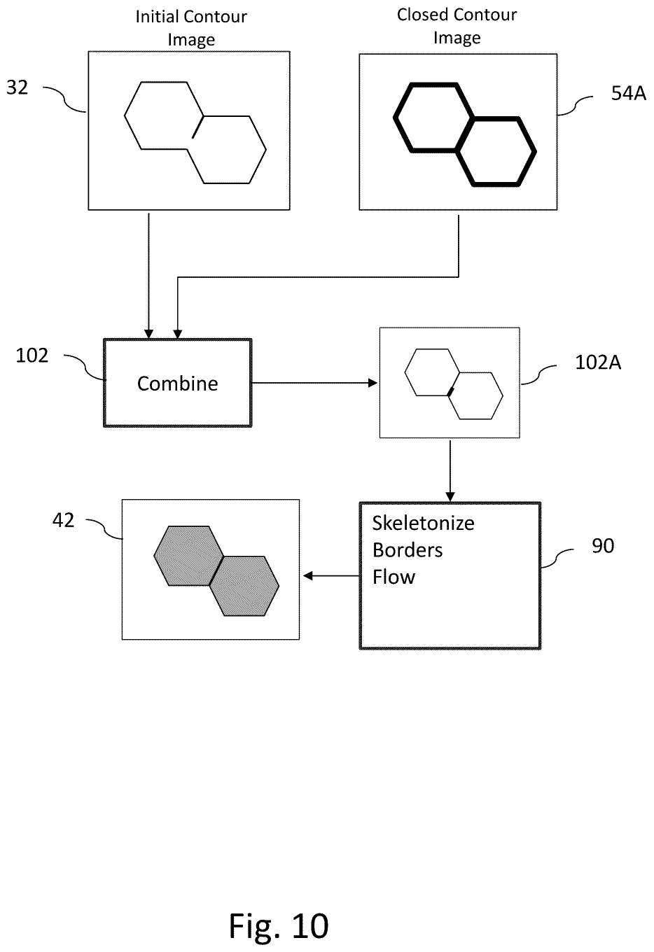

FIG. 10, to which reference is now made, is a schematic illustration of an optional flow of postprocessing module 52 that uses information from initial contour image 32 in addition to the closed contour image 54A, to improve the shape of final segmented image 42 compared to what is created by skeletonize border flow 90 or by delate polygons flow 80.

Postprocessing module 52 may receive initial contour image 32 and closed contour image 54A. In step 102, postprocessing module 52 may combine initial contour image 32 and closed contour image 54A creating a combined image 102A. Combined image 102A may contain the original parts of the contours of initial contour image 32 and the parts of the contours added by CCGM 54 for closing the gaps. It may be noted that the contours originated in closed contour image 54A may be thicker than those originated in initial contour image 32. Image 102A is then provided to skeletonize border flow 90 that creates a border image 43 as final segmented image 42.

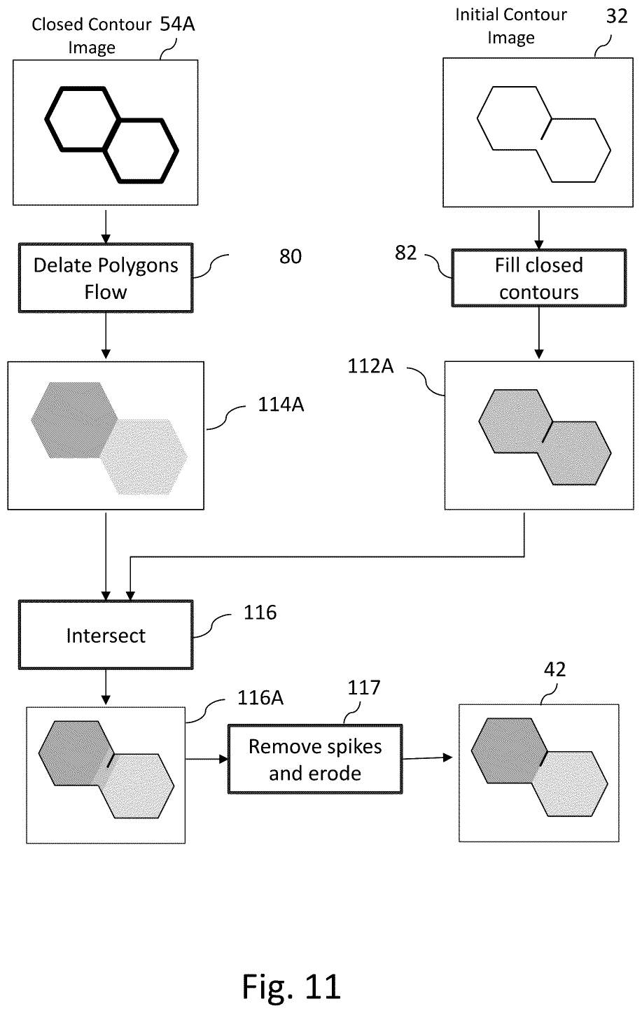

FIG. 11, to which reference is now made, is a schematic illustration of an additional optional flow of postprocessing module 52 to improve the accuracy of final segmented image 42 using initial contour image 32 in addition to closed contour image 54A. Postprocessing module 52 may receive initial contour image 32 and fill each closed contour with pixels representing a specific object, creating image 112A with segments spanning multiple objects. Postprocessing module 52 may in addition receive closed contour image 54A and use delate polygon flow 80 to create polygon image 114A where the polygon of each object is a bit larger than the objects in initial contour image 32. In step 116, postprocessing module 52 may separately intersect each polygon in image 112A and image 114A potentially creating an image 116A where the per-object polygons may contain spikes intruding into each other's space. In step 117, postprocessing module 52 may remove the spikes and erode excess pixels in overlapping areas until there are no intersections between polygons and create final segmented image 42 which may be of type polygon image 44.

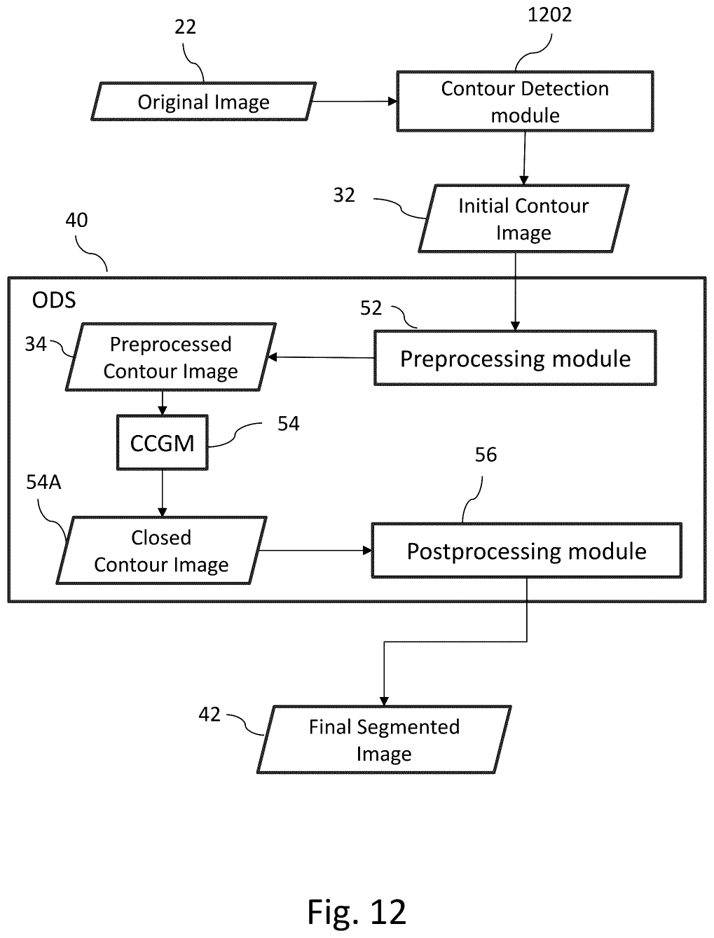

FIG. 12, to which reference is now made, is a schematic illustration of a pipeline performing instance segmentation inference using ODS 40 to improve object delineation.

Original image 22 may be processed by any contour detection tool, including any standard semantic segmentation model configured to identify the ‘border’ class. The resulting initial contour image 32 may be the input to ODS 40 that may process it as described with respect to FIG. 5. Preprocessing module 52 may operate on initial contour image 32 as described with respect to FIG. 6 and create a preprocessed contour image 34 that may be fed to CCGM 54. CCGM may be trained to create closed contour image 54A as described with respect to FIG. 7. Postprocessing module 56 may handle closed contour image 54A as described with respect to FIGS. 8-11 and may create final segmented image 42, with delineated objects effectively providing instance segmentation.

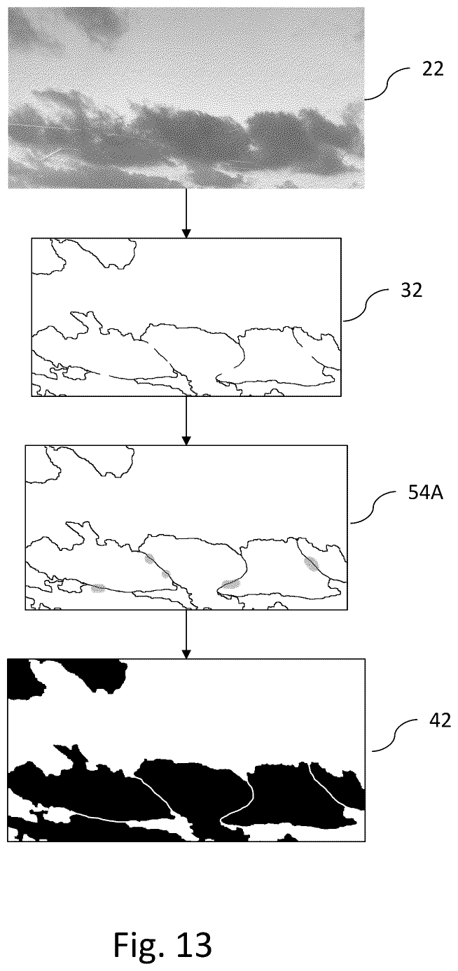

FIG. 13, to which reference is now made, is an example of images created in the various steps of the pipeline described with respect to FIG. 12, from original image 22 through initial contour image 32, closed contour image 54A and final segmented image 42.

It may be noted that postprocessing module 52 may identify any closed contour as an object, including parts that may be at the edges of the image or areas trapped between objects that form a closed contour.

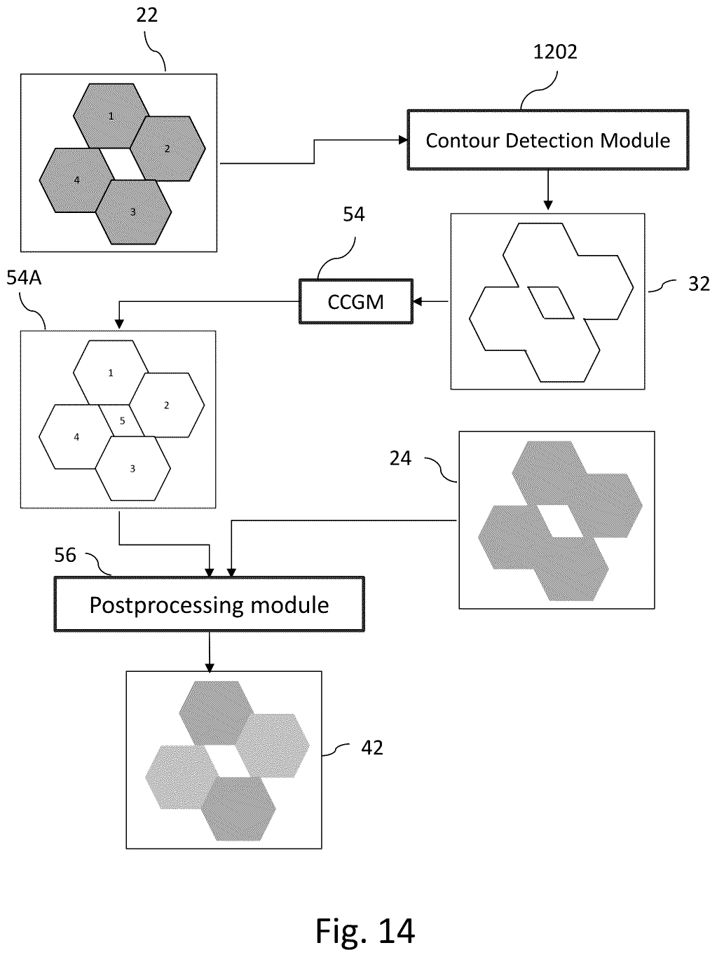

FIG. 14, to which reference is now made, is a schematic illustration of an alternative embodiment of postprocessing module 52 that may receive Image 24 (FIG. 2) that is the outcome of a standard semantic segmentation model in addition to closed contour image 54A and uses it to distinguish between areas inside closed contours being the objects of interest and other closed areas that are not objects such as area 5 in closed contour image 54A.

Postprocessing module 56 may improve the accuracy of the contours by additionally using the information of image 24 for deciding which closed contour is a border of an object and therefore should be turned into a polygon. When an image includes partially seen objects, postprocessing module 56 may also use the frame of image 24 to close contours of objects.

Embodiments of the invention provide systems and methods for delineating individual objects in images by utilizing semantic segmentation techniques and provide a methods and systems capable of providing instance segmentation using a semantic segmentation model.

Embodiments of the invention provide a generic model that may be used in a pipeline to classify individual instances of various object types and is therefore generic in this aspect. Embodiments of the invention may be agnostic to the contour detection module that creates the initial contour image 32 from the original image 22. Embodiments of the invention may also be agnostic to the type of objects which are delineated and do not require calibration to handle different images and object types and are agnostic to the characteristics of the dataset.

Other embodiments of the invention may also provide a specialized model capable of closing open contours with specific characteristics and/or creating contours with the shape of specific objects for which the model was trained to close.

Embodiments of the invention provide a border processing system ODS 40 that uses CCGM 40 and is capable of identifying adjacent distinct instances of a class by applying a standard semantic segmentation model on original images 22 to segment the respective border class, potentially creating incomplete contours in initial contour images 32, use the new generic model CCGM 40 to fix incomplete contours in initial contour images 32 with the and create closed contour images 54A with each close contour identifying an object.

Embodiments of the invention may be used instead of instance segmentation when instances are close to each other so that if semantic segmentation is applied as-is, they get classified into the same segment. The embodiments may provide good instance delineation. Most existing instance segmentation models are slower in training and inference compared to semantic segmentation, require more resources, and provide inferior prediction results, due to the need to solve the more challenging problem of instance separation, compared to embodiments of the invention.

It may be appreciated by the person skilled in the art that the steps shown in the different flows described herein are not intended to be limiting and that the flows may be practiced with more or less steps, or with a different sequence of steps, or any combination thereof.

It may also be appreciated by the person skilled in the art that the different parts of the system, shown in the different figures and described herein, are not intended to be limiting and that the system may be implemented by more or less parts, or with a different arrangement of parts, or with one or more processors performing the activities of the entire system, or any combination thereof.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type and any electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may include apparatus for performing the operations herein. This apparatus may be specially constructed for the desired purposes, or it may comprise a general-purpose computer, a graphics processing unit (GPU), a general-purpose computing on graphics processing units (GPGPU), A tensor processing unit (TPU) or any other processing units and hardware components selectively activated or reconfigured by a computer program stored in the computer. The resultant apparatus, when instructed by software, may turn the general-purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, Solid-State Drive (SSD), read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description above. In addition, embodiments of the invention are not described with reference to any particular programming language. It will be apparent to persons of ordinary skill in the art that a variety of programming languages may be used to implement the teachings of the invention as described herein.

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the invention.

What is claimed is:

1. A system comprising:
at least one memory;
at least one processor communicatively coupled to the memory; and
an object delineation system (ODS) operated by the at least one processor, the ODS comprising a Closed Contour Generic Model (CCGM) which is a machine learning model trained to close gaps in contours;
wherein the ODS is configured to:
receive an initial contour image comprising contour information of a plurality of objects, wherein the contour information contains one or more gaps thereby constituting a first number of gaps,
utilize the CCGM to close at least one gap in the initial contour image, and
create a closed contour image comprising contour information of the plurality of objects wherein a quantity of gaps in the closed contour image is smaller than the first number,
wherein the ODS further comprises a postprocessing module configured to create a final segmented image where each object is distinctly identified, and
wherein the postprocessing module further comprises a skeletonize borders flow configured to
skeletonize the contours in closed contour image, and
fill closed contours in closed contour image with pixels representing a specific object.

2. The system of claim 1 wherein the ODS further comprises a preprocessing module configured to prepare the initial contour image to be utilized by the CCGM.

3. The system of claim 2 wherein the preprocessing module is configured to:
reduce a resolution of the initial contour image;
skeletonize borders in the initial contour image;
increase a contrast between the borders and a background; and
dilate the borders.

4. The system of claim 1 wherein the CCGM is a semantic segmentation model.

5. The system of claim 1 wherein a training set used to train the CCGM includes a variety of images with incomplete contours.

6. The system of claim 1 wherein the postprocessing module further comprises a delate polygon flow, the delate polygon flow configured to:
polygonise and remove the contour around objects in closed contour image; and
dilate objects in closed contour image.

7. The system of claim 1 wherein the postprocessing module is further configured to:
receive an output generated by a standard semantic segmentation model that has processed an original image; and
decide which closed contour in closed contour image is a contour of an object and create an object segment exclusively for contours of objects.

8. The system of claim 1 wherein the postprocessing module is further configured to:
receive initial contour image; and
combine contour information of original parts from initial contour image and contour information added by the CCGM for closing the gaps from closed contour image.

9. A computer-implemented method comprising:
receiving an initial contour image comprising contour information of a plurality of objects, wherein the contour information contains one or more gaps thereby constituting a first number of gaps;
utilizing a machine learning model trained to close gaps in contours to close at least one gap in the initial contour image;
creating a closed contour image comprising contour information of the plurality of objects wherein a quantity of gaps in the closed contour image is smaller than the first number;
filling closed contours in closed contour image with pixels representing a specific object;
polygonising and removing the contour around objects in closed contour image; and
dilating objects in closed contour image.

10. The method of claim 9 further comprising preparing the initial contour image to be utilized by the CCGM.

11. The method of claim 9 further comprising:
reducing a resolution of the initial contour image;
skeletonizing borders in the initial contour image;
increasing a contrast between the borders and background; and
dilating the borders.

12. The method of claim 9 wherein the CCGM is a semantic segmentation model.

13. The method of claim 9 wherein a training set used to train the CCGM includes a variety of images with incomplete contours.

14. The method of claim 9 further comprising:
receiving a closed contour image; and
creating a final segmented image where each object is distinctly identified.

15. The method of claim 14 further comprising:
skeletonizing the contours in closed contour image; and
filling closed contours in closed contour image with pixels representing a specific object.

16. The method of claim 14 further comprising:
receiving an output generated by a standard semantic segmentation model that has processed an original image; and
deciding which closed contour in closed contour image is a contour of an object and creating an object segment exclusively for contours of objects.

17. The method of claim 15 further comprising:
receiving an initial contour image; and
combining contour information of original parts from initial contour image and contour information added by the semantic segmentation machine learning model for closing the gaps from closed contour image.
